(19) United States
(12) Patent Application Publication
(10) Pub. No.: US 2009/0319423 A1
(43) Pub. Date: Dec. 24, 2009

(54) INCENTIVE PROGRAM

(76) Inventor: Robert D. Kersenbrock, Lake Mary, FL (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/144,929

(22) Filed: Jun. 24, 2008

(51) Int. Cl. G06Q 30/00; G06Q 20/00

(52) U.S. Cl. 705/41

(57) ABSTRACT

An incentive program is described that rewards the participants of the program based on the actions of at least something other than the participants. The incentive program may be used with a cardholder account and a currency card operable to debit the cardholder account, with the participants of the incentive program being the cardholders. The incentive program is operable to receive one or more picks of something other than the cardholder from the cardholder, determine the amount of rewards owed to the cardholder based on the performance of the one or more pick, deposit the determined amount of rewards into the cardholder account, and convert at least a portion of the rewards in the cardholder account into one or more additional picks of something other than the cardholder.

### TECHNICAL FIELD

The present invention relates to business methods particularly, but not exclusively, to business structures and methods that reward a participant in an incentive program based on the performance of at least something other than the participant and convert rewards into additional picks of at least something other than the participant.

### BACKGROUND

Incentive programs are well known. Common examples of incentive programs are frequent flyer miles programs or credit cards that give a program participant rewards based on every purchase made by the participant using the card. These incentive programs seek to attract new customers or participants in the incentive program by offering them rewards in exchange for actions that they take. For example, in a typical frequent flyer miles program, the participant obtains miles for each plane ticket that they purchase from a particular airline. If the participant purchases a significant number of airline tickets, for example in excess of $5,000 worth of airline tickets in a year, the participant gets a certain amount of free airplane tickets as a reward. The purpose of such programs is that once the participant begins the program they are less likely to switch airlines because of their vested interest in the amount of rewards that they have already earned. Plus, the participant obtains rewards for what they already perceive as expenses that they will have to pay. Therefore, the airline increases its market share and loyal customer base. Of course, this type of incentive program is simply illustrative and there are many different types of incentive programs that exist.

As another example, incentive programs that use additional parties are also known. For example, a credit card company may form a partnership with a gasoline company in order to increase the sales for both companies. They do so by creating an incentive program. The incentive program is commonly structured such that every time the participant purchases gasoline from the gasoline company using a credit card offered by the credit card company, they gain credits toward future purchases of gasoline. Thus, a participant who consumes a lot of gasoline over the course of time or prefers one brand of gasoline over others would be motivated to obtain such a credit card. Once the participant is obtained, additional credit card transactions are made. As a result, the merchant who offers the gasoline must pay additional credit card fees thereby improving the revenue of the credit card company. Plus, the gasoline company wins because the participant purchases gasoline under their brand and not their competitor's brands. The participant is incented to use the credit card so that they gain the benefit of the credits that they earn through purchasing gasoline with the card over time. Finally, the participant is happy because the gas that they already had to buy is now a little bit cheaper because of the credits they earned based on the purchases that they made. Therefore, this is an incentive program having a structure of three parties: a sponsor (the gasoline company), a credit card issuer (the company that provides the credit card) and a participant (the consumer who purchases gasoline).

Yet another form of an incentive program is an employer/employee program designed to increase the sales of its employees. The employees participate in the incentive program that is coordinated by an incentive program coordinator. Upon certain types of activities by the employees, rewards are earned. For example, if the employees hit a certain level of sales, then the incentive program coordinator offers free vacations to various locations. The employer pays the incentive program coordinator a fee for offering these services and in return the employer hopes the incentive program improves the sales of the employer by stimulating the employees.

Incentive programs are therefore operated in a variety of ways. They can include multiple participants, multiple incentive program operators, currency card issuers, employers, or a variety of other structures and methods of doing business. Heretofore, all of the incentive programs, however, have all based the rewards provided to the participant based on the participant's own actions. For example, the amount of money the participant spends on airplane tickets determines how many miles they receive. In the credit card example, the amount of gas purchased from the certain gasoline company, the number of credit card uses or the amount of money spent by the participant determines the amount of rewards provided. Similarly, the amount of sales or other actions by the employees determines the amount of incentives that they receive.

Therefore, needs remain in this area.

### SUMMARY

In certain embodiments, a system comprises a cardholder account, a currency card operable to debit the cardholder account, and an incentive program system. The incentive program system is operable to receive one or more picks of something other than the cardholder from the cardholder, determine the amount of rewards owed to the cardholder based on the performance of the one or more picks, deposit the determined amount of rewards into the cardholder account, and convert at least a portion of the rewards in the cardholder account into one or more additional picks of something other than the cardholder.

In certain embodiments, a method comprises the steps of providing a currency card to a cardholder operable to debit a cardholder account, operating an incentive program associated with the cardholder account for use with an event having at least two event participants, and providing the cardholder the ability to select at least one of the participants of the event as a pick. The method further comprises the steps of depositing rewards in the cardholder account based on performance of the selected participant of the event and converting at least a portion of the rewards into at least one additional pick of event participants.

In certain embodiments, a method comprises the steps of operating an incentive program, entering participants in the incentive program, and providing each of the participants a participant account. The method further comprises the steps of providing a selection of at least two of something other than the participant to each participant to be chosen as at least one pick, rewarding the participants if their chosen picks achieve a predetermined performance level by depositing rewards into the corresponding participant accounts, and automatically converting unused amounts of the deposited rewards into at least one additional pick for each affected participant of something other than the participant after a predetermined elapsed time from depositing the rewards into the participant accounts.

In certain embodiments, a system comprises an incentive program operable to provide the choice of at least two participants in at least one event to a cardholder for the cardholder to choose from, wherein the cardholder has a cardholder account and a currency card operable to debit the cardholder account, and receive at least one selection of at least one event participant from the cardholder. The incentive program is further operable to deposit points into the cardholder account when the at least one selected participant achieves a predetermined performance level with respect to the event, receive instructions from the cardholder to convert at least one of the points in the cardholder account to at least one additional selection of at least one participant in at least one event, and convert the at least one point to at least one additional selection according to the received instructions.

### BRIEF DESCRIPTION OF THE DRAWINGS

FIG. 1 illustrates a schematic block diagram of one embodiment of the present disclosure.

FIG. 2 illustrates a schematic block diagram of an alternate embodiment.

FIG. 3 illustrates a schematic block diagram of yet another alternate embodiment.

FIG. 4 illustrates a schematic block diagram of a further alternate embodiment.

FIG. 5 illustrates a schematic business structure diagram according to one embodiment.

FIG. 6 illustrates an alternate schematic business structure diagram according to another embodiment.

FIG. 7 illustrates a further schematic business structure diagram according to another embodiment.

FIG. 8 illustrates a schematic block diagram of an embodiment of a method in a television framework.

FIG. 9 illustrates a schematic block diagram of another embodiment of a method in a video game framework.

FIG. 10 illustrates a schematic block diagram of a further embodiment of a method in a digital music framework.

FIG. 11 illustrates a schematic block diagram of a further embodiment of a method in a beverage company framework.

FIG. 12 illustrates a schematic block diagram that uses an incentive program as a method to poll the participants of the incentive program.

FIG. 13 illustrates a schematic block diagram of a multi-variety incentive program business structure that can be offered by a currency card issuer.

FIG. 14 illustrates a schematic block diagram of a method in an awards ceremony framework.

FIG. 15 illustrates a schematic block diagram of another embodiment of the present disclosure.

FIG. 16 illustrates a schematic block diagram of yet another embodiment of the present disclosure.

### DETAILED DESCRIPTION OF THE SELECTED EMBODIMENTS

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended. Any alterations, modifications, and further applications of the principles of the present disclosure as illustrated are contemplated as would normally occur to one skilled in the art to which the disclosure relates.

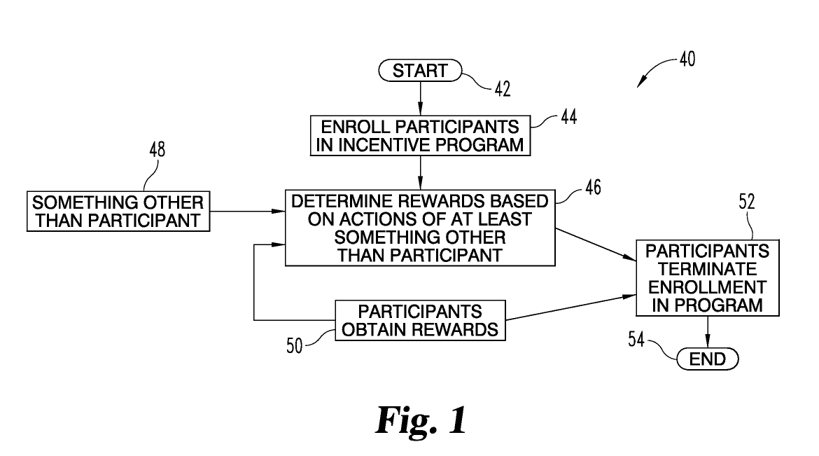

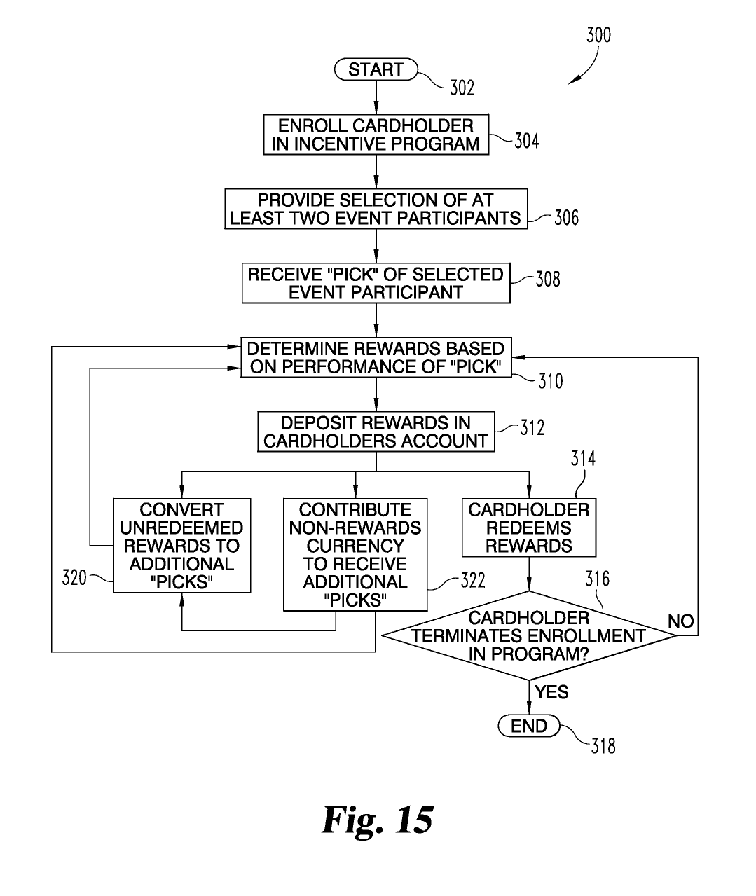

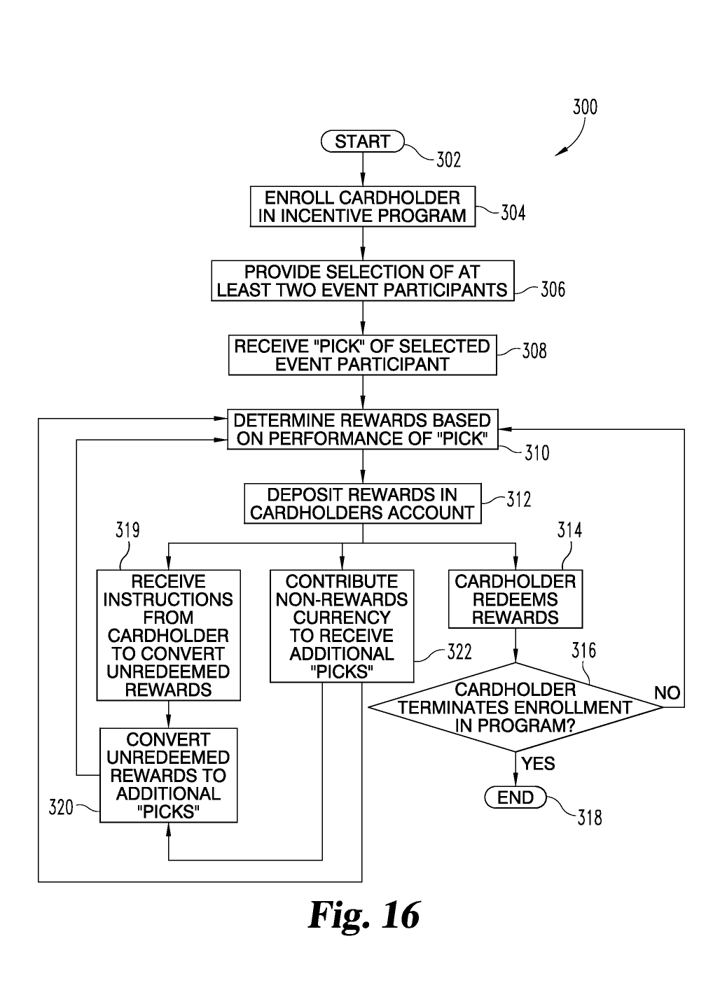

The present disclosure is directed to various embodiments of methods and systems involving incentive programs which reward participants based on the performances of something other than the participants. The incentive programs of the present disclosure may be used in conjunction with cardholder accounts, wherein cardholders are issued currency cards operable to debit their particular cardholder account, with the participants of the incentive program being the cardholders. In certain embodiments, the incentive program is operable to receive one or more picks of something other than the cardholder from the cardholder, determine the amount of rewards owed to the cardholder based on the performance of the one or more pick, deposit the determined amount of rewards into the cardholder account, and convert at least a portion of the rewards in the cardholder account into one or more additional picks of something other than the cardholder. The conversion of rewards will be discussed in greater detail with reference to FIGS. 15 and 16, while other various embodiments regarding the operation of the incentive programs will be discussed with reference to FIGS. 1-14.

For explanation purposes, specific examples of the principles of the disclosure will be described in the next two following examples. It is to be understood, however, that no limitation of the disclosure is intended by the description of these two specific examples. The claims define the present disclosure and the following examples are merely used to illustrate possible operating procedures for the various embodiments of incentive programs and are not to be used to alter the scope of the disclosure described in the claims. After these few specific examples are described, a more broad description of different embodiments that are contemplated by the present disclosure is provided along with corresponding drawings thereto. Even these broader descriptions are not intended to alter the scope of the disclosure defined by the claims.

One specific example is an incentive program that rewards participants based on the performance of their favorite sports team. The participant in the incentive program is an individual who lives in St. Louis and loves football. The participant obtains a credit card from a bank, like Citibank®, and enters an incentive program that is available for eligible customers of the bank. The individual is eligible because he is carrying a balance on the card, has no late payments, and has used the card at least five times over the past month. The incentive program provides incentives to the individual card holder based on the performance of a third party sports team. The participant chooses the St. Louis Rams and is rewarded every time the St. Louis Rams wins a game, scores a touchdown, scores a field goal, etc. The rewards are points on the participant's credit card. For an illustration of how points can be awarded reference to U.S. Pat. No. 5,025,372 is suggested.

The second example concerns an individual who lives in Cincinnati and loves baseball. The individual receives a credit card from Citibank®. The individual is eligible to enroll in an alternate incentive program because the card has a balance, no payments are late, and the individual has used the card five times over the past month. This alternate incentive program bases the rewards on the performances of individual athletes in a given sports category. This is similar to the structure used in sports fantasy leagues. The individual chooses Ken Griffey Jr. of the Cincinnati Reds. The program awards points, like those in the U.S. Pat. No. 5,025,372 patent, to the individual based on the performance of Ken Griffey Jr. Thus, if Ken Griffey Jr. has two homeruns, four hits, and one steal in one night and a homerun is worth 10 points, a hit 2 points, and a steal 5 points then the individual earns 33 points based on Ken Griffey Jr.'s performance.

Generally speaking, an incentive program is described that rewards the participants of the program based on the actions of at least something other than the participants. As used herein, “incentive program” includes the use of sweepstakes, parimutuel distributions and other types of rewards that are readily apparent to those skilled in the art in light of this specification. An incentive program coordinator that can be an individual, a legally created entity, or other organization can run the incentive program. Some examples of legally created entities are limited liability companies, limited liability partnerships, corporations, limited partnerships, partnerships, S-corporations, and trusts to name a few non-limiting examples. The incentive program coordinator can have business relations with the participating entities. The participating entities can be individuals, legally created entities, or other organizations. The incentive program coordinator can also have business relations with a sponsor or another business entity. The participants of the incentive program receive rewards based on the performance of at least something other than the participants. For example, the participants in one embodiment could receive rewards based on the actions of a favorite sports team. If the sports team performs well, the participant gets more rewards. Therefore, the participant obtains rewards regardless of whether their own performance or actions are desirable. In other embodiments, the participant also influences the amount of rewards received along with the performance of something other than the participant.

Referring now to the drawings, FIG. 1 illustrates an incentive program 40 according to one embodiment of the present disclosure. The incentive program 40 is illustrated as a process in a schematic form with a start block 42 and an end block 54. First, an entity is enrolled into an incentive program at block 44 thereby becoming a participant in the incentive program. In block 46, the amount of rewards to be given to the participant based on actions by at least something other than the participant is determined. The term “at least something other than the participant” is intended to be anything besides solely the participant itself. For example, an unrelated third party, such as a sports team or company, could have their performance evaluated to determine if rewards are given to the participant. The sports teams could be at a professional, high school, college, or any other level. Moreover, other examples include, but are not limited to, famous athletes, a country, a race horse, or a race car. If the participant is a racetrack fan, rewards based upon the race horse performance would be desirable to the participant or if the participant is an investor, rewards based upon stock market performance would be desirable to the participant. Alternatively, “at least something other than the participant” could be another participant in the incentive program. Moreover, a combination of the participant's actions and “at least something other than the participant,” could determine the rewards.

The amount of rewards to be provided to the participant in block 46 is determined by receiving input from at least something other than the participant 48. If the amount of rewards to be given were based on sports team performances, the performance of the relevant sports team(s) would be provided to block 46. For example, if the rewards were based on a professional football team score, the score would determine the amount of rewards provided. Alternatively, if at least something other than the participant was the performance of a stock, the amount of dollars that the stock went up over the course of a certain period could be used to determine the amount of rewards provided. In another embodiment, if a country was the “at least something other than the participant,” then the strength of the currency compared to other currencies could determine the amount of rewards. In another embodiment, the amount of times a horse wins races over the course of a certain period could determine the amount of rewards. Other types of actions of things other than the participant that are readily apparent to those skilled in the art in view of the present disclosure are also contemplated

The information concerning the performance of at least something other than the participant can be obtained by any method readily apparent to those skilled in the art. For example, databases run by companies such as ESPN or other sports related entities could be utilized in order to determine the amount of points to be awarded. The determining of the points to be awarded could also be performed by an incentive program coordinator. The incentive program coordinator could be an entity such as an individual or a corporation. The individual or corporation could use a computer method or any other method readily apparent to those skilled in the art to obtain and process the information concerning the performance of at least something other than the participant.

Next, the participants can either obtain the rewards as shown in block 50 or terminate the enrollment in the program as shown in block 52. The participants can obtain the rewards in a variety of different manners. In some embodiments, the participants obtain the rewards by receiving points, miles, credits, or any other quantum of value that could be accessed by a credit card. In other embodiments, the rewards are provided by simply sending cash in the form of a check or money order directly to the participant. In some other alternate embodiments, the rewards can be tickets to a sporting event or discounts on food served at the sporting event. In other embodiments, the rewards are the ability to meet one of the famous players of a favorite sports team of the participant. In further embodiments, the rewards are coupons that are redeemable at selected merchants. In further embodiments, the rewards are gift certificates that could be realized at a number of merchants or providers of entertainment, travel rewards, or merchandise that can be ordered or obtained through any medium. In some other embodiments, the rewards could be the granting of an option to buy a stock or a mutual fund at a certain lower-than-market price. Alternatively, the rewards could be the reduction in the amount of points or fees charged by a mutual fund company to invest in their funds. As one skilled in the art would readily recognize, there are infinite types of rewards that could be provided to the participant in the incentive program.

As block 52 illustrates, participants can terminate enrollment in the program. This termination of enrollment in the incentive program could either be voluntary or involuntary. For example, in an incentive program where a credit card is used, enrollment might be involuntarily terminated by the program coordinator if the credit card user fails to use the credit card a minimum number of times per a designated time period. Alternatively, the participant may voluntarily decide to leave the incentive program. Therefore, the participant may lose all of the credits earned for them by the third party actions, or the combination of their actions and the third party actions, or in some embodiments the credits gained could be converted to a transferable amount of value. In addition, the participant may simply decide to switch to a different incentive program coordinator that allows the transfer of the quantum of value earned between programs. Also, the participant simply can terminate their involvement to choose a different third party whom they believe will have more success in earning rewards for the participant. Once the entity is no longer participating in the incentive program 40, the incentive program 40 for that participant comes to an end as represented by block 54.

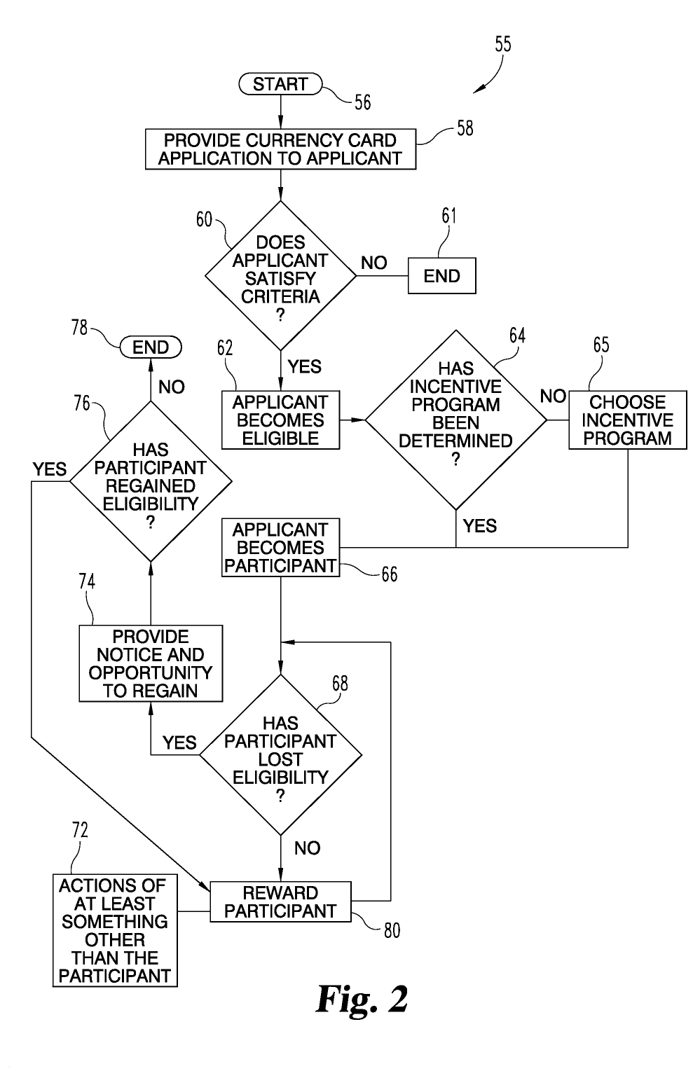

An alternate embodiment is illustrated in FIG. 2. The alternate embodiment is also illustrated as a process in schematic form. In this embodiment, the process 55 begins at the start block 56. The first step is to make a currency card application available to an applicant, as shown in block 58. The next step, shown in decision tree 60, determines if the applicant satisfies criteria for enrollment into the incentive program. If the applicant does not satisfy the criteria, the process ends at block 61. If the applicant does satisfy the criteria, however, the applicant becomes eligible to enroll in a selected incentive program or programs, as illustrated in block 62. Whether applicant is participating in an incentive program is determined next, as shown in decision tree 64. If the applicant has previously elected to participate in an incentive program, then the algorithm moves to block 66. If the applicant has not previously elected to participate in an incentive program, then they get the ability to choose the incentive program they would like to participate in, as shown in block 65. At block 66 the applicant then becomes a participant in the incentive program and in some embodiments an incentive program membership identifier is provided to the participant. The incentive program membership identifier can be a currency card, an account number, an electronic signature, computer password, and/or other identifier readily apparent to those skilled in the art. Then the eligibility to participate in the program is checked in block 68. If the participant has not lost eligibility, then the participant gets rewarded, shown at block 70, based on the actions of at least something other than the participant, shown in block 72. If the participant has lost eligibility, then notice and opportunity to regain eligibility is provided to the participant, as shown in block 74. If the participant has regained eligibility, as determined at decision tree 76, then the participant is rewarded in block 70. If the participant hasn't regained eligibility after providing notice and opportunity to regain eligibility the process ends at block 78.

Referring to block 58, a currency card as used in this application means any type of card that can be used to perform monetary transactions. For example, a credit card, a debit card, a check card, or other type of card that can use currency as a medium of transfer is contemplated. The application for a currency card can be made available to applicant in a variety of ways. For example, the applicant can seek an application to join an incentive program at a card issuer's web site, address, or by calling the card issuer. Alternatively, mailings of applications for credit cards or debit cards can be provided to participants at their home. In addition, corporations can be contacted at their place of business to provide an application for a currency card. Also, the application could simply be for entering into the incentive program. For example, an already established cardholder could add the incentive program as an additional benefit to their existing cardholder agreement with the credit card company, or enrollment in the incentive program could result in the automatic issuing of a currency card to the new participant. In addition, the applications could be offered directly, such as at college campuses or other forms of direct marketing. Therefore, any possible way readily apparent to those skilled in the art of providing the materials to an applicant are contemplated.

At decision tree 60, the applicant is scrutinized to determine if they satisfy the criteria necessary to be eligible in an incentive program. Alternatively, eligibility can also be automatically provided, in some embodiments, thereby starting the process at decision tree 64. For example, a currency card issuer provides a credit card to a large number of participants who already qualify.

If eligibility is to be determined, the determination can be performed in various ways. For example, the fiscal strength of the applicant can be scrutinized, in some embodiments. This can be done by doing credit checks, requesting verification of income or other funds, or by any other method readily apparent to those skilled in the art.

In some alternate embodiments, the analyzed criteria are demographic information about the applicant. For example, in one embodiment the something other than the participant is the Democratic Party and the participant is a staunch Democratic Party supporter. Determining the political affiliation of the participant may be necessary to enter the applicant into the incentive program that rewards the participant based on the performance of the Democratic Party. Alternatively, if the applicant is a younger individual, the performance of something other than the participant could be the record sales of their favorite music artist, thus, determining the applicant's favorite artist would be necessary.

In some other embodiments, the criteria analyzed could be the purchasing patterns of the applicant. For example, if the applicant was an already existing customer, information about where applicant shops could be determined and the applicant could be entered into an incentive program corresponding thereto. For example, suppose the purchasing records of the applicant shows that they shop at Lowe's® every time home improvement materials are needed. If the incentive program rewards were credits that could be applied at Home Depot® the applicant may not meet the criteria to participate in (i.e. would not be interested in) an incentive program that rewards by providing Home Depot® credits. Other analyzing of criteria can use a combination of some or all of the above mentioned indicators. Furthermore, other types of eligibility information readily apparent to those skilled in the art are also contemplated.

At block 62 when the applicant becomes eligible, the applicant may or may not have determined an incentive program in which to enroll (as determined by decision tree 64). The type of incentive program, if not already chosen, is determined at block 65. In some embodiments, the applicant can choose the incentive program in which they would like to participate. In some of these embodiments, the applicant can choose to participate in more than one incentive program or can switch incentive programs during their period of participation. Alternatively, the incentive program can be predetermined for an applicant. For example, perhaps the currency card issuer would provide an application for the professional football team of that applicant's metropolitan area. If the applicant decides to fill out the application and they qualify, then they are enrolled into the incentive program where the amount of rewards is provided based on the performance of that specific professional football team. Alternatively, as shown in block 65, in some embodiments the applicant can choose their own incentive program. For example, if the applicant's favorite football team is located in another state, they may choose that favorite football team. It is contemplated by the present disclosure that the applicant can even chose aspects of the incentive program, such as which players of their professional football team performances will determine their rewards.

Once the applicant becomes a participant at block 66, it is necessary to determine if the participant has lost eligibility at decision tree 68. In some embodiments, the participant cannot lose eligibility. Once the participant has started participating in the program, they are participating in the program until the program itself comes to an end or the participant withdraws from the program. In other embodiments, however, the participant can lose eligibility. For example, in one embodiment, in order to stay in the program, the participant must use their currency card a certain amount of times over a certain time period. To illustrate, if the currency cardholder uses the currency card five times in a month, then the currency card owner remains eligible to stay in the incentive program. However, if they use their card less than five times per month, then they lose the right to participate in the incentive program (at least for that month). Similarly, a program based on the amount of expenditures is contemplated. In addition, in some other embodiments the participant could lose eligibility by failing to make a payment on their currency card or by having a late payment during the month.

Moreover, in other embodiments, the participants can enter themselves into an earning status by satisfying certain criteria. In other words, the participant, while enrolled, has not gained the ability to obtain rewards until they satisfy certain criteria. For example, the participant must use their card at least three times a month before they are eligible to receive points in some embodiments. In other embodiments, the participant needs to dine from a selected group of restaurants a certain number of times a month. Those skilled in the art will recognize that there are an infinite number of factors that can be used to determine if a participant has obtained an earning status.

In some embodiments, upon the loss of eligibility, the participant loses all of the rewards earned for them by something other than the participant. In other embodiments, the participant can “cash out” their rewards at the end of their participation. In other embodiments, eligibility is only suspended for the month during which the participant failed to satisfy the requirements for eligibility. In addition, in the illustrated embodiment, in block 74 the participant is provided notice of the fact that they have lost or are about to lose their eligibility and provided an opportunity to reestablish eligibility. For example, if the participant has to use the credit card at least five times in a month and the participant fails to do so, the participant is notified of such failure and is given the opportunity to begin using the card once again five times a month. Alternatively, the participant may have to use the card at a higher frequency to regain eligibility, for example six times per month.

The notice could be provided in any manner readily apparent to those skilled in the art. For example, notice could be provided in the credit card statement bills sent monthly. Alternatively, the e-mail address of the participant could be obtained and an e-mail notification sent to their e-mail address. In some embodiments, the notification could be separate from the credit card statement. In other embodiments, the notice is provided by a telephone call. After the participant has given notice and an opportunity to regain eligibility, eligibility is checked again at decision tree 76. Eligibility could be regained by any manner apparent to those skilled in the art. As shown in block 70, the participant is then rewarded based on at least something other than the participant. This can continue indefinitely. It is noted, once again, that the rewards can be determined from a plethora of options. Cash, checks, points, tickets to a sports team, discounts on food at an event, gift certificates, coupons, plane tickets, commodities, stocks, travel rewards, merchandise that can be ordered or obtained through any medium, or any other reward readily apparent to those skilled in the art are contemplated.

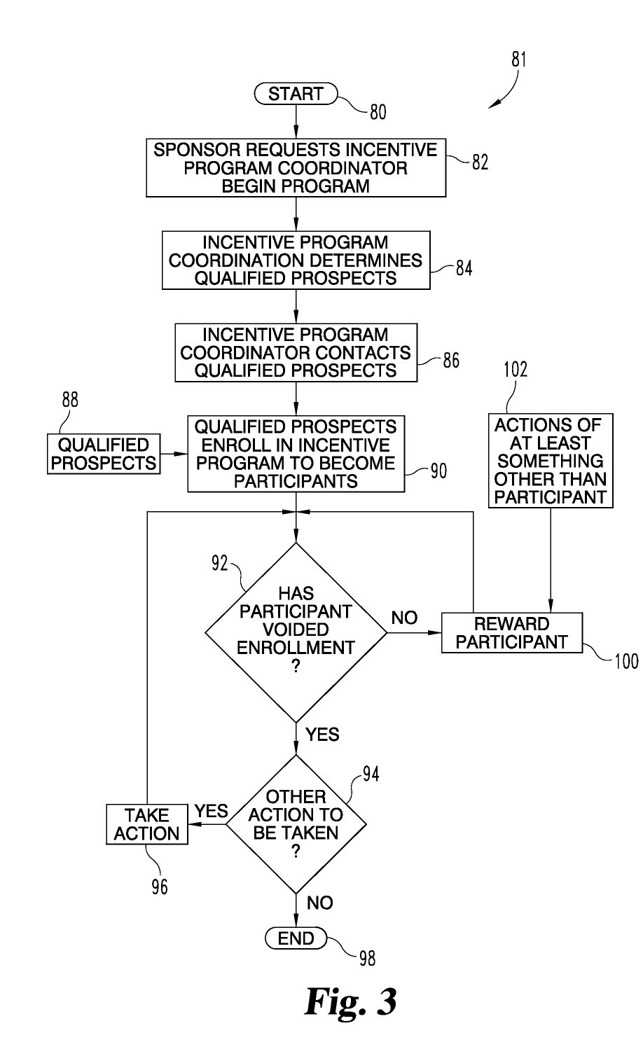

Referring now to FIG. 3, an alternate embodiment as illustrated. As in FIGS. 1 and 2, the embodiment illustrated in FIG. 3 is a process 81. The process begins at start block 80 and moves to block 82. At block 82, a sponsor requests that an incentive program coordinator begin an incentive program. Next, in block 84, the incentive program coordinator determines qualified prospects. Once the incentive program coordinator determines the qualified prospects, they then contact the qualified prospects as shown in block 86. Upon being contacted by the incentive program coordinator, the qualified prospects, as shown in block 88, can enroll in an incentive program and become a participant as shown in block 90. Once the participants are established, then at decision tree 92 it is determined whether or not the participants have voided their enrollment. If the participant had voided enrollment, the algorithm then moves next to decision tree 94 to determine if there is any action that needs to be taken. If there is action to be taken, then the action is taken at block 96. If there is no other action to be taken, then the algorithm ends at block 98.

If the participant has maintained enrollment in the incentive program, then the participant is rewarded at block 100 based on the actions of at least something other than the participant 102. Once the participant is rewarded, the process returns to determining if they have voided enrollment 92. If they haven't voided enrollment, then the participant continues to be rewarded until enrollment is voided. In some embodiments, enrollment can be voided simply by the passing of time. It is contemplated, however, that the participant will continue to be rewarded based on the non-participant actions until the year of enrollment has finished, in some embodiments. The participant can be rewarded in a variety of manners like those discussed with respect to the embodiments illustrated in FIGS. 1 and 2.

Referring to block 82, the sponsor could be any entity desiring to start an incentive program. For example, the sponsor could be a sports team, a mutual fund company, a corporation, or an individual. The sponsor wants to create an incentive program in order to create a buzz about their product or services. In addition, the sponsor may be attempting to increase the number of customers of their product or service or may be attempting to do test marketing or other types of business activities. The incentive program coordinator can be an organization, individual, or any other entity readily apparent to those skilled in the art. The incentive program coordinator may contact the participants directly or use an alternate company to help locate the participants. The incentive program coordinator also sets up the boundaries, regulations, rules, and other aspects of the incentive program.

Referring to block 84, the qualified prospects can be determined from a variety of factors. Demographic data, financial strength data such as credit scores and analysis of net worth and purchasing patterns are all types of information that could be used in some embodiments in determining a qualified prospect. The incentive program coordinator may already be in possession of this type of information, there may be other entities who have this information, or they can obtain it in any other method readily apparent to those skilled in the art. Qualified prospects are used in this embodiment because the sponsor is paying a fee in order to obtain a desired result. In the other embodiments, the contacting of participants can be random since anyone may be the intended participant. Conversely, in the present embodiment, the sponsor likely desires to attract a certain group that they are attempting to reach. For example, if the sponsor were a sports team, they likely would only be interested in contacting fans of the sport. If the sponsor were an investment company, they likely would only want to contact people who would be interested in investing or have the money to do so. Contacting the qualified prospects can be done in any manner readily apparent to those skilled in the art.

Block 92 determines whether the participant has voided enrollment. The participant could void the enrollment based upon the rules that were put together by the incentive program coordinator. If the rules require that a certain amount of money be spent over a certain period of time and the participant had not done so, then they may have voided their enrollment. Alternatively, if the participant was required to attend a certain number of sports games in a year in order to qualify for the incentive program, failing to attend those games could void them. It would be readily apparent to those skilled in the art that an infinite amount of situations could be imagined that could result in the voiding of enrollment.

At block 94, whether or not action needs to be taken is determined. For example, in some embodiments, the incentive program coordinator attempts to contact the participants. This could be in the form of contacting the participant and informing them that they are soon to lose their eligibility to participate in the incentive program and that could result in a loss of the rewards or credits obtained until that point of time. In other embodiments, as soon as the eligibility is voided that means the participant is no longer participating in the incentive program and there is no ability for the participant to change their status. Different embodiments have different types of action to be taken or can even decide to take no action at all.

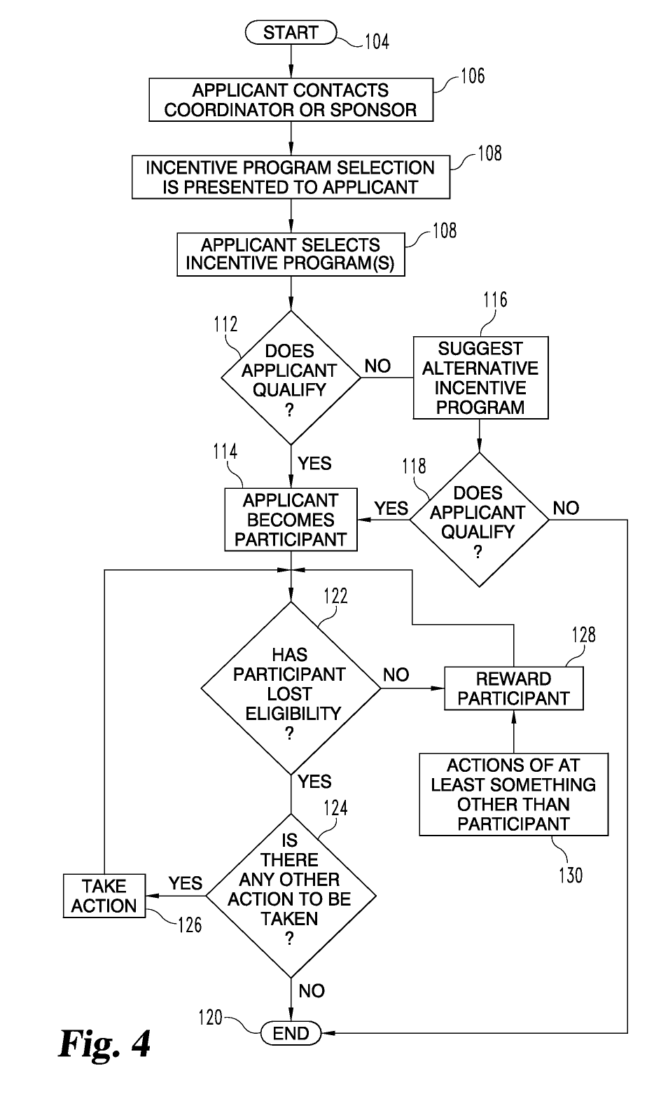

Referring now to FIG. 4, another embodiment of the present disclosure is illustrated. The method starts at block 104 and then moves to block 106. At block 106, the applicant contacts an incentive program coordinator or sponsor. After the applicant contacts the coordinator or sponsor, the coordinator or sponsor provides an incentive program selection to applicant at block 108. The applicant then selects the incentive program at block 110. The selection can be made electronically, or by filling out paperwork if contacted by mail or any other method readily apparent to those skilled in the art. Then at decision tree 112, it is determined whether or not an applicant qualifies to enter the chosen incentive program. This qualification can be based on a variety of factors, as listed before, such as financial strength, credit information, purchasing decisions and the like. If the applicant does qualify, the applicant becomes a participant as shown in block 114. Alternatively, if the applicant does not qualify for the program they selected, the incentive coordinator or the sponsor can suggest an alternate incentive program that applicant may qualify for as shown in block 116. After an alternative incentive program has been presented, the method again moves to decision block 118 and determines whether or not the applicant qualifies for the alternative incentive program. If the applicant does, the applicant becomes a participant at block 114. If the applicant does not qualify for an alternative incentive program, then the method ends at block 120.

Once the applicant becomes a participant then the method illustrated on blocks 92-102 in FIG. 3 is repeated. First it is determined whether or not the participant has lost eligibility in block 122. If they have, it is then determined if there is any other action to be taken at block 124. If there is not, then the algorithm ends at block 120. If so, then action is taken at block 126 and the algorithm goes back to determining if the participant has loss of eligibility again at block 122. If the participant has not lost eligibility then the participant is rewarded at block 128 based on the actions of at least something other than the participant in block 130.

Referring to block 106, the applicant can contact the coordinator or sponsor through any method apparent to those skilled in the art. For example, in one embodiment the applicant contacts the sponsor at the web site of the sponsor. The applicant may be a sports fan that visits the web site of the sports team and wants to participate in the incentive program sponsored by the sponsor or coordinated by the coordinator. As shown in block 110, in the embodiment illustrated in FIG. 4, a structured level of programs are provided. This can have many beneficial aspects. For example, if the sponsor is a sports team, fans with a higher level of loyalty, who are motivated to purchase more often, can be enrolled in a higher level incentive program. Similarly, fans that are wealthier individuals can be part of a VIP-type incentive program. Therefore, the sponsor may be better able to reward those that are more loyal to them. For instance, if the fan is a season ticket holder, then the fan could be enrolled in an incentive program where fifty incentive points are earned for every touchdown. In contrast, if the fan only attends one or two games a year, then perhaps they could only obtain five points per touchdown. It is readily apparent to those skilled in the art that an infinite amount of permutations could be expanded upon and still stay within the principles of the embodiment illustrated.

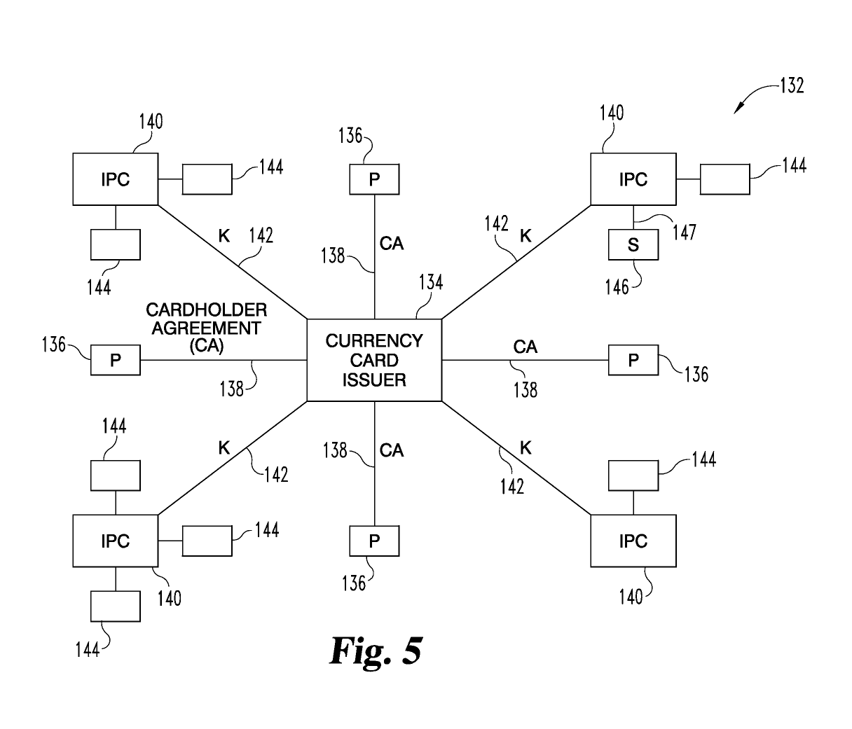

FIG. 5 illustrates a business structure 132 according to one embodiment. A currency card issuer 134 provides currency cards for use by a plurality of participants 136. The pluralities of participants 136 are operatively coupled to the currency card issuer by means of a legally binding contract. Generally, these contracts are known as Cardholder Agreements, shown as 138. The Cardholder Agreements spell out the legal relationship between the currency card issuer 134 and the participants 136. They commonly will describe the terms, interest rate, credit balances and other aspects of the agreement. In addition, the incentive program designated or chosen by the participant will likely also be discussed in the Cardholder Agreement 138.

The currency card issuer 134 is also operatively coupled to the incentive program coordinators (IPC) 140. In the illustrated embodiment, the incentive program coordinators are operatively coupled to the currency card issuer 134 through the use of a legal contract 142. Other embodiments contemplate other business relationships. For example, the incentive program coordinator 140 and the currency card issuer 134 could be the same entity in some embodiments. It is also contemplated that other embodiments can have more or less incentive program coordinators. In one embodiment, only one incentive program coordinator 140 is operatively coupled to currency card issuer 134 through a contract 142. Other embodiments contemplate even more incentive program coordinators 140. The incentive program coordinators 140 administer the incentive programs that reward the participants 136 based on the actions of at least something other than the participant 144. The incentive program coordinators 140 take information about the actions of at least something other than the participant 144. It could be only one something other than participant 144 as shown in the lower right hand corner of FIG. 5. Conversely, there could be a plurality of at least something other than participants 144 whose performance is evaluated to determine the amount of rewards provided to the participant 136. An incentive program coordinator 140 that takes information from a plurality of at least something other than the participant 144 is shown in the lower left-hand corner. For example, one incentive program coordinator can coordinate all the information concerning all the professional football teams in the United States. Other incentive program coordinators could have a contract with just one professional football team to run their officially sponsored incentive program. It should be readily apparent to those skilled in the art that an infinite variety of relationships between at least something other than the participant 144 and the incentive program coordinator 140 can be contemplated. In addition, in the upper right hand corner of FIG. 5, a sponsor (S) 146 is shown operatively coupled to incentive program coordinator 140 through the use of a legally binding contract 147. The sponsor in the illustrated embodiment pays a fee to the incentive program coordinator 140 and the incentive program coordinator 140 reviews information based on a third party 144. The sponsor 146 has an incentive for doing so to promote the third party, or itself, to a large group of participants that are connected to the currency card issuer as cardholders.

In operation, the structure works as follows. The participant 136 enters into a Cardholder Agreement 138 with the currency card issuer 134. The currency card issuer 134 has created a contract called a Cardholder Agreement 138 which sets the amount of interest rate, annual fees and other types of information pertinent to use of the currency card. The participant 136 can be automatically enrolled into the incentive program simply by virtue of entering into the Cardholder Agreement or could separately choose the incentive program that they desire. For example, in the illustrated embodiment, the incentive program coordinators 140 could all each be taking information for a different sport. Therefore, one incentive program coordinator could coordinate basketball, the other could coordinate football, the other could coordinate baseball, and the last could coordinate golf. The participant 136 could have the option of choosing which incentive program they desire based on the sport that they enjoy the most. Alternatively, the currency card issuer 134 could issue applications that automatically make the participant a member of a designated incentive program simply by entering into the Cardholder Agreement 138.

The incentive program coordinator 140 is legally bound to the currency card issuer 134 through a contract. In the illustrated embodiment, the currency card issuer 134 pays the incentive program coordinator 140 a fee in exchange for the incentive program coordinator 140 running the incentive program. The currency card issuer 134 has an incentive to do so in order to create more sales by having more participants 136 want cards issued by the currency card issuer 134 so they can become eligible for the incentive program. In addition, the eligibility requirements for the incentive program may incent the participant 130 to take actions that increase the revenue generated for the currency card issuer 134.

For one example, the participant could be attending a game of their favorite football team and notice that two touchdowns were scored leading to 100 points obtained on their card. It should be appreciated, however, that an incentive program coordinator 130 can modify the earn ratios at any time in different embodiments. The 100 points could be redeemable at the game for free food or drinks. In this hypothetical example, suppose the 100 points earned the participant $5 of credit towards any food or drink purchase at the game. Because the participant knows they have $5 worth of free food, the participant goes up to the counter and orders two pretzels that each cost $3. The participant desires to obtain their rewards, and not waste any, so they order over the amount of their credit. The original price of all the food is $6 minus the $5 credit, so they are spending $1 more than they would without the reward. Plus, they are making the entire purchase with their card, instead of cash or other payment method. This increases the amount of credit card sales. The merchant (i.e. the concession stand) has to pay the currency card issuer 3% on all sales accepted and paid for by credit cards. The currency card issuer 134 receives more fees from various merchants because the participant 136 is encouraged to use their card to obtain the rewards earned for them by the at least something other than the participant 144. Therefore, the currency card issuer 134 has motivation to pay the fees to the incentive program coordinator 140 in order to increase their sales.

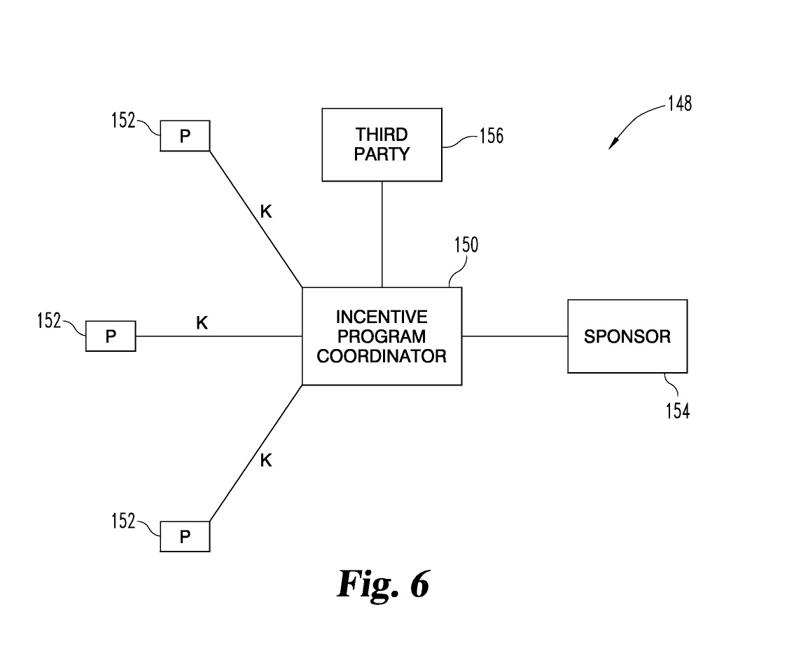

FIG. 6 illustrates an alternative business structure 148. In this embodiment, there is no currency card issuer. The incentive program coordinator 150 is operatively coupled to participants 152 by any known manner, such as a legally binding contract. This coupling could occur various number of ways. For example, the incentive program coordinator 150 may already have contact with the participants 152 as they are employees of an employer who has requested the services of the incentive program coordinator 150 to increase their sales. The sponsor 154 therefore could be the employer themselves or another entity.

For example, the sponsor 154 could be a mutual fund company that desires to sell funds to the employees of a company. The incentive program coordinator 150 already working with that company has an incentive program for its employees 152. Therefore, the incentive program coordinator 150 that is already existing with employee/participants 152 can be contacted by a new sponsor 154 to create an alternate incentive program. The incentive program coordinator 150 can take information about the performance of at least something other than participants and use it as a measure to reward the participants 152. The at least something other than the participants 152 could be a third party 156.

For one example, the third party 156 could be the employer of the participants 152. The mutual funds company 154 can provide additional rewards based upon the performance of the employer 156. To illustrate, the mutual fund company 154 could reduce the amount of fees that it takes for contributions to the fund or it could allow the purchase of additional shares of the fund at a discount to the employees upon an improvement in the employer's performance. Such a structure synergistically provides dual incentives to the employees. The employees would already be participating in the other incentive program operated by incentive program coordinator 150, such as a sales promotion or the like. Thus, when the participants 154 achieve greater sales under the first program they are rewarded once. Plus, the greater sales improve the performance of employer 156 which stimulates the mutual funds company to provide investment products for cheaper to the employees thereby rewarding the employees twice. The mutual funds company then increases the amount of employers that sign onto their program by hiring the incentive program coordinator to operate the program.

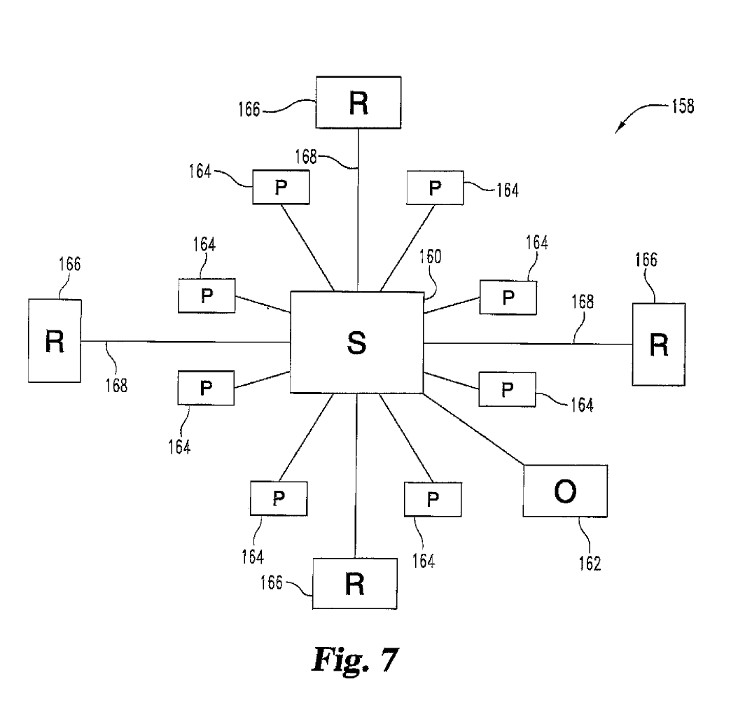

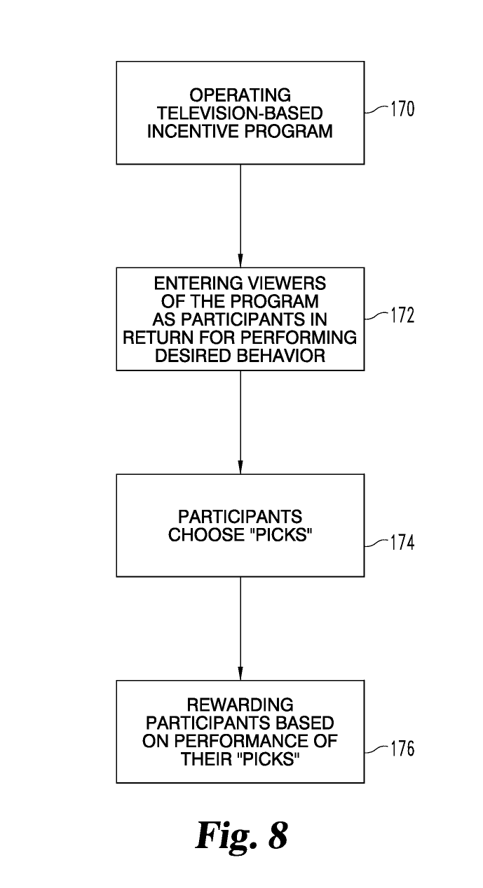

In another embodiment, the business structure 158 is organized as illustrated in FIG. 7. In this embodiment, the incentive program coordinator is also simultaneously the program sponsor (S) 160. In some embodiments, the incentive program can be licensed from an originator (O) 162 as illustrated in FIG. 7. In other embodiments, the program sponsor may work with a co-sponsor such as a currency card issuer. The partnership with the co-sponsor is mutually beneficial with the currency card issuer gaining exposure and increasing sales and the program sponsor connecting with an entity that already has a developed rewards program. In other embodiments, the incentive program coordinator and the program sponsor (and/or co-sponsor) are separate entities. Those skilled in the art recognize that a variety of business relationships can be created to implement the incentive program effectively. The program sponsor 160 administers the incentive program and determines who can become participants illustrated as (P) 164. In some embodiments, the participants 164 must have certain qualifications to be entered as a participant 164 in the incentive program, such as by being a cardholder of a co-sponsor entity. In other embodiments, anyone can become a participant 164. As in the other business structures disclosed and claimed herein, the participant 164 is awarded based on the performance of at least something other than the participant. In other words, third party performance or a combination of the third party performance and the participant's performance are integrated within a loyalty framework. In addition, the rewards may be administered by the program sponsor 160, the co-sponsor, or can be provided by operatively coupling with third-party rewarding entities (R) 166 via legal contracts 168. A few concrete examples are provided below in relation to FIGS. 8-11, and 13 to illustrate how the business structure 158 would operate.

As one example, shown by the method illustrated in FIG. 8, the program sponsor 160 could be a television network or program. In some embodiments, the television program is a reality television program having non-actor individuals as members of the program cast (i.e. contestants). In this embodiment, the television program licenses an incentive program from another entity and operates the incentive program themselves as illustrated in step 170. The television program is operatively coupled to the program's viewers as participants in the program. By watching the television program or performing other desired actions such as obtaining a select currency card, the viewers are entered as participants in the incentive program in step 172. Once the participants are entered they can choose their “picks” from the non-actor individuals participating in the program as illustrated in step 174. As used herein, the term “picks” is defined as any entity that is chosen by a participant to be at least one of the entities whose performance determines the amount of rewards awarded to the participant.

After the participants choose their “pick” or “picks,” the performance of those “picks” on the television program determines the amount of rewards that the participants obtain as shown in step 176. The number of “picks” that are available to be chosen by the participants can vary based on the participant's own performance in some embodiments. For example, if the participant is a habitual viewer of the television program or logs onto the corresponding website for the program a certain amount of times, the participant may receive more “picks.” In addition, if the rewards are tied with a currency card issuer, in some embodiments the level of use of the currency card can entitle the participant to a certain number of “picks.”

A concrete example would be the television show American Idol®. American Idol® is a “reality” television program that uses non-actor individuals as members of the television show. In some embodiments, the program sponsor could be a currency card issuer, such as Citibank®, or, as discussed previously, the incentive program could simply be licensed from a third party and operated directly by the American Idol® production company and/or the television network or channel (or other entity having a financial interest in the television show). In this embodiment, American Idol® operates the incentive program. American Idol® enters into a variety of contracts with different vendors to provide rewards to viewers. One vendor is Citibank®, who agrees to inform American Idol®, or a third party who is administering the incentive program, when a participant spends over a certain dollar amount so that additional “picks” by the participant are allowed. In addition, Citibank® agrees to reward cardholding viewers (participants) with a certain amount of points based on the performance of the viewers' picks.

A television viewer turns on their television and begins to watch American Idol® and is informed that if they are a Citibank® cardholder they may be eligible to make one or more “picks” of the contestants to win extra points. The viewer exercises their “pick” or “picks” (such as by logging onto an associated web site) and as the show progresses they are awarded points based on the performance of their chosen contestant. The viewers become “incented viewers” because of this ability to obtain points based on the performance of their “pick” or “picks.” Citibank® increases their customer base because of the desire of viewers to be able to participate. Depending upon the program eligibility requirements, Citibank® may also increase their sales so that the viewers are eligible to participate. American Idol® ensures that the viewers will watch their show each week because of the incentives that can be obtained by the performance of the “pick” or “picks,” thereby increasing the price they can charge for their advertising. Accordingly, reality television becomes completely interactive as viewers are rewarded by the performance of their “picks.”

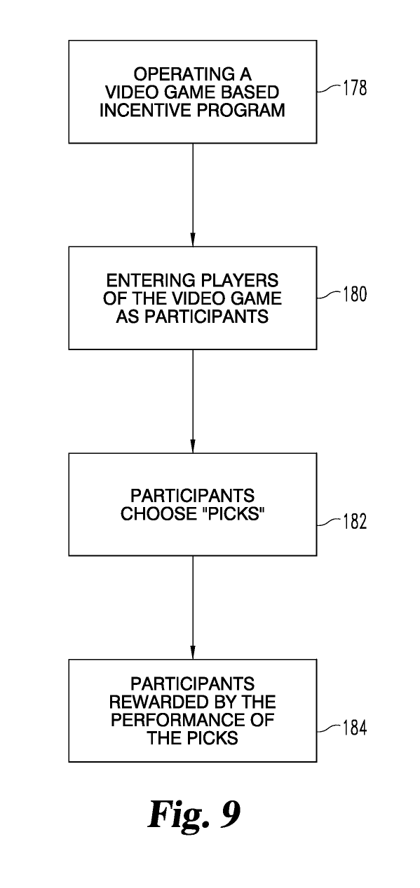

The concept can be applied to other fields. For example, in the method illustrated in FIG. 9, the program sponsor is a video game manufacturer, such as Sony®. Sony® is about to release a highly-anticipated video game that is interactive for players nationwide through access to the internet. Sony® creates and operates an incentive program in step 178 that each video game player can obtain a certain number of “picks” that are relevant to the video game in return for playing the video game on-line or being an on-line subscriber. Sony® is thereby encouraged to use these incentive programs as a way to increase their on-line game usage sales. After playing on-line, the video game players become participants as illustrated in step 180. They can choose their “picks” as illustrated in step 182 and then are rewarded based at least in part on the performance of their “picks” as illustrated in step 184. For example, if the video game was a sports game the “pick” would be a favorite athlete upon whose performance the amount of rewards may be based. The athlete's reward generating performance may be in real life athletic contests, as a character in the video game athletic contest (e.g. the character's performance in all games played on the network), or a combination of the two. The rewards could be sports tickets, credits that can be applied to the purchase of additional games, free on-line time, sports merchandise and clothing, credits awarded to a currency card, or anything else of value. In other embodiments, the “picks” could be other video game players or groups of video game players, to name just a few of the potential “picks.”

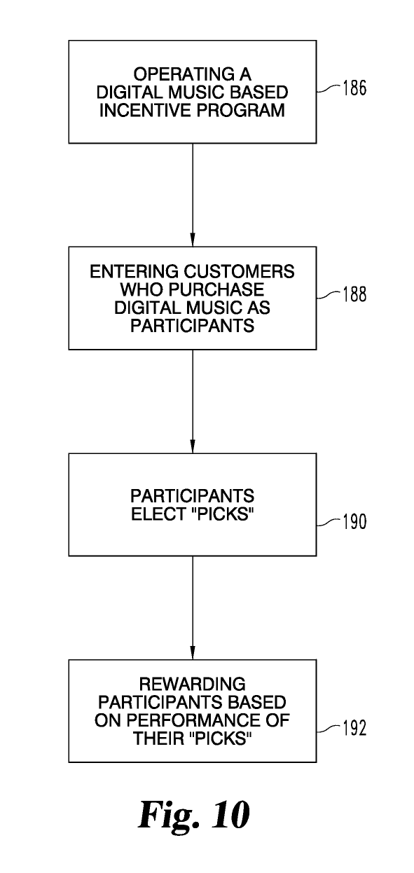

Along similar lines, another method is illustrated in FIG. 10. A commercial company that sells digital music on-line can create and operate an incentive program as illustrated in step 186. In some embodiments, the participants of the incentive program would be the customers of the company as illustrated in step 188. The company could create an incentive program that provides a certain number of “picks” based on the amount of songs downloaded by the participant in a month. For instance, if a user downloaded an entire album the user becomes a participant who is awarded three “picks.” The participant then chooses a number of “picks” as illustrated in step 190. The “picks” could be used for a variety of different rewards programs and the performance of the “picks” would determine the amount of rewards obtained by the participant, as illustrated in step 192. The “picks” could be a sports athlete whose performance results in the obtainment of points for a currency card. Alternatively, the “picks” could be used for a certain artist whose record sales, and/or chart position, and/or number of downloads, and/or awards obtained at an awards ceremony could determine the amount of rewards. The rewards could also comprise concert tickets, free downloads, or backstage passes to name a few, depending on the contracts secured by the commercial digital music company.

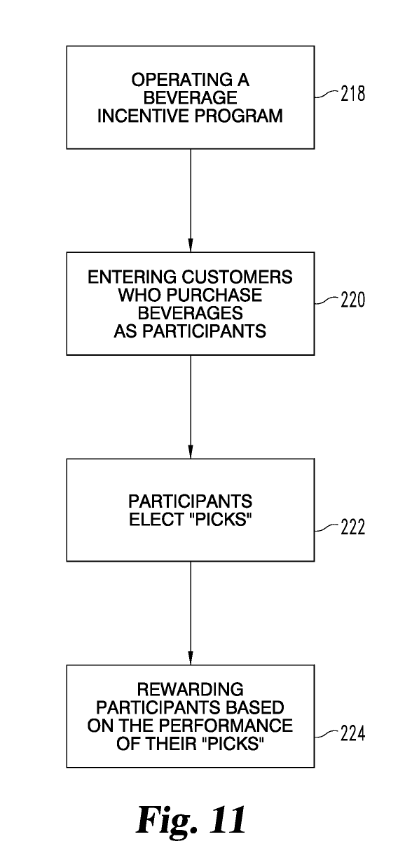

Continuing along the same lines, another method is illustrated in FIG. 11. A commercial company of beverages like Pepsi® operates a program in step 218 whereby certain beverage products produced by the company have unique identifiers and web-site addresses printed on the inside of the screw cap or can. This information is used to register for the Pepsi® incentive program via, for example, the internet or telephone. After purchasing the Pepsi® product the consumer opens the bottle or can, finds the printed information and enrolls in the Pepsi® incentive program in step 220. As a Pepsi® incentive program participant, the consumer is allowed to select from a variety of “picks” in step 222 that include incentive program alternatives (such as reality television shows, sports, or television awards) and a particular entity (such as a character, athlete or team) whose performance determines the number of points awarded in the incentive program. These points can be used for rewards established by Pepsi® in step 224. For example, if the participant selected the Saint Louis Rams as their “pick” and the Rams scored 30 points in a particular game, the participant might earn 60 Pepsi® incentive points. As with all of the examples detailed herein, those skilled in this art will recognize that the “picks” and the rewards can be varied.

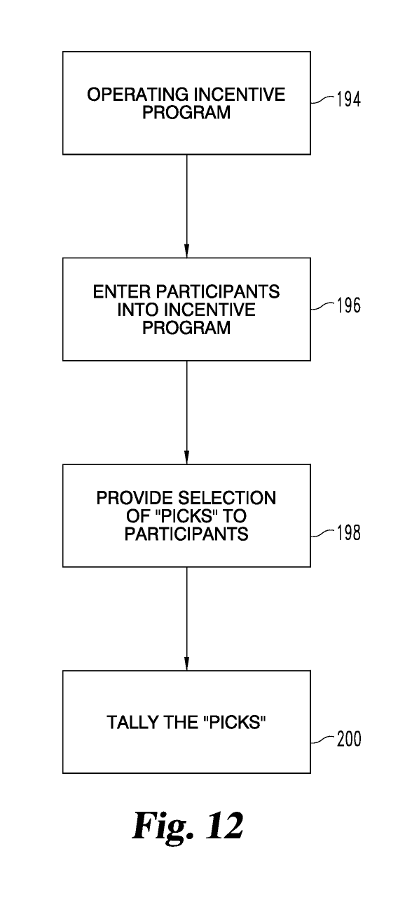

In all of the different embodiments discussed, the “picks” could also be used as a polling means. The method illustrated in FIG. 12 teaches how such a polling means would operate. Initially, the incentive program would have to be in operation as illustrated in step 194 and participants would have to be entered as shown in step 196. Next, a selection of different “picks” would be presented to the participants as shown in step 198. After these selections were made, the picks can then be tallied as illustrated in step 200. For instance, in American Idol® the amount of people who exercise their “pick” for a certain contestant could be determined and displayed on the screen to see who the qualified viewers think is the best contestant. Similarly, this polling feature could be used in the other disclosed embodiments.

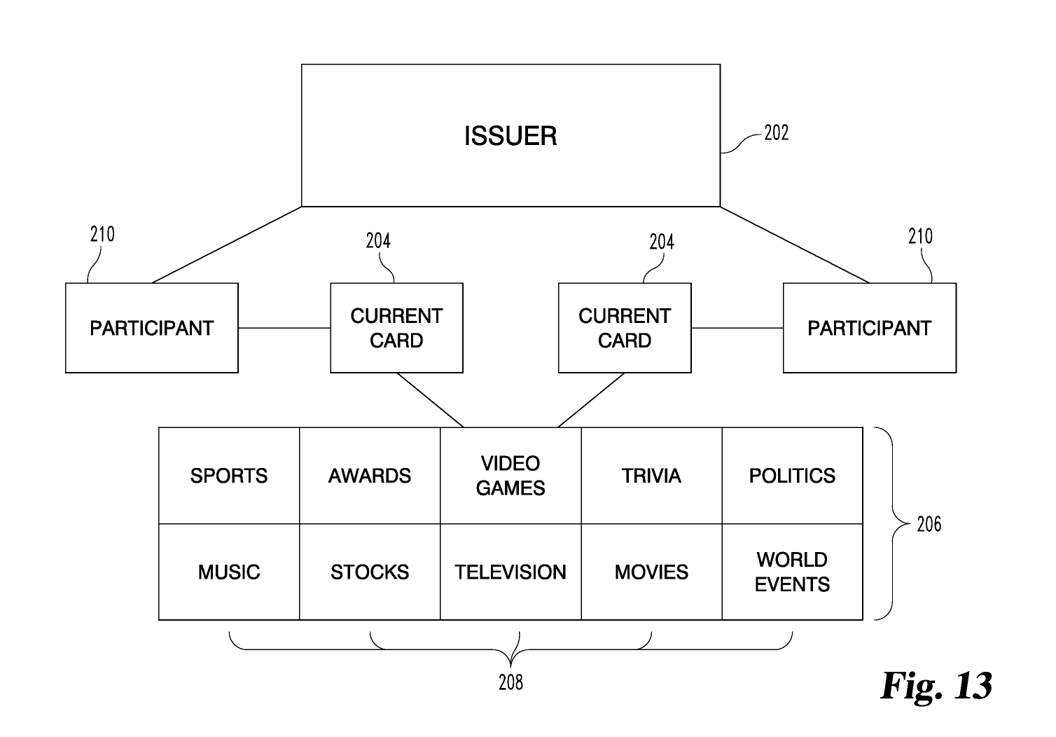

One example of how a variety of incentive programs can be utilized by one currency card issuer is illustrated in FIG. 13. Initially, there is an issuer 202 that issues a currency card 204 to one or more participants. Each currency card 204 is associated with at least one incentive program 206 that has a plurality of varieties 208. For example, the incentive program varieties 208 could be directed to sports, politics, award shows, video games, music, the stock market, or television shows, to name a few non-limiting examples. The participants 210 can then choose to participate in one or more varieties 208 of the incentive program 206 based upon the number of “picks” they have earned. For example, suppose a user is incented to open a new credit card account because they get six “picks” to earn rewards when they open an account. By opening the new card account and choosing at least one “pick” the user becomes a participant 210 into the incentive program. As a hypothetical example, suppose the participant decides to choose their favorite football and basketball team, the Democratic party, their favorite music artist to win an award at the Grammy® Awards, their company's stock performance and a certain character on their favorite reality T.V. show. They now have used all six of their “picks” and will be rewarded on the basis of their “picks” performance. As discussed in the description for FIG. 1 presented earlier, the card issuer can be the sponsor of the incentive program and the rewarder of the points simultaneously, either the sponsor or the rewarder, or even third parties can perform either the sponsor or rewarder functions. Accordingly, the participants can choose which varieties 208 they want to participate in and therefore can align their interests with the possibilities of rewards.

Moreover, as a further incentive, the rewards can also be tied into the performance of participants versus each other. For example, suppose in the above example, the hypothetical person's “picks” performed very well, earning them lots of rewards. The hypothetical person could earn additional awards for being in a certain percentile of winners for a preceding time period. Alternatively, they could be awarded additional rewards for earning more rewards than a selected group of competitors, or some combination of both percentile ranking and performance versus a group.

In addition, the rewards may include entry into a sweepstakes or, alternatively, be indexed in a parimutuel arrangement. A sweepstakes is a system where participants are entered into a drawing for the chance to win additional rewards. For example, a consumer enrolls in an incentive program and meets certain behavioral requirements such as minimum monthly usage of an incentive card. As a result of meeting the minimum usage requirements the participant is allowed to pick a favorite team and is awarded points for the team's performance. If the total number of points earned exceeds a minimum value, the participant is entered into a drawing with other qualifying participants for the chance to win additional incentive program points or other prizes.

A parimutuel distribution of rewards is a system where the entire group of rewards that is available to a limited number of people is placed together in a pool, fees are deducted for the administrator, and the rewards are divided up evenly among all of the winners. Therefore, the winners only are taking the rewards lost by the losers minus the administration fees. For example, if the New York Yankees® were chosen as the favorite sports team, and they were chosen by most participants to be their baseball team, commonly because they are the highest ranked team with the highest opportunity to earn points, then the amount of rewards that could be earned for choosing that team may be altered to reflect their odds of success. Along these same lines, a low ranked team may be adjusted to produce additional awards because of their low likelihood. Accordingly, in some embodiments, the rewards can adjust with the perceived superiority of the “picks.” In other embodiments, the rewards can be adjusted dynamically based on the number of “picks” assigned by participants to a particular third party.

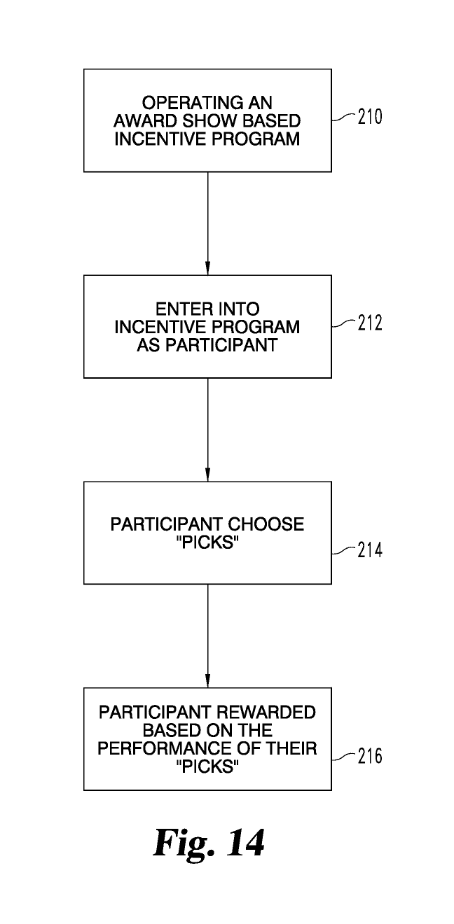

FIG. 14 illustrates another method where the “picks” can be made for upcoming awards programs. The first step is to operate an incentive program that centers around award shows as illustrated in step 210. For example, the Country Music Awards^{SM}, the Academy Awards®, the Grammy® Awards, and the MTV awards are examples of some of the awards programs that can be targeted. Combining this example with the example illustrated in FIG. 13, a participant 210 could choose the awards program as one of their varieties 208 and be entered into the incentive program as a participant as illustrated in step 212. In other embodiments, the participants can be entered in other ways. Next, the participants choose their picks in step 214. For instance, suppose the Academy Awards® is scheduled for the upcoming month and Tom Cruise has been nominated for best male actor in a movie. A participant 210 could choose Tom Cruise as their “pick” or, alternatively, choose one of the other actors who also have been nominated for the award. The participant will receive rewards based on the performance of Tom Cruise in the awards ceremony as illustrated in step 216. Similarly, this concept can be extended to other areas of the entertainment industry, such as using a “pick” on which movie might return the biggest showing at the box office for the following month.

In addition, it is to be understood that the “picks” or the “at least something other than the participants” can change over the course of operation of the incentive program in any of the discussed or contemplated embodiments. Moreover, in any of the embodiments the “picks” or the “at least something other than the participants” could be required to be revalidated upon the passing of a period of time. Those skilled in the art recognize that the rewards and “picks” are subject to change during the operation of any incentive program. In some embodiments, the “picks” must be exercised in a certain time frame. Alternatively, in other embodiments, there are no time limitations. Those skilled in the art will recognize that the incentive programs disclosed herein may be administered using a computer or a network of computers executing software written to implement the ideas disclosed and claimed herein.

The conversion of rewards will now be discussed with reference to FIGS. 15 and 16. FIG. 15 illustrates an incentive program 300 according to another embodiment of the present disclosure. The incentive program 300 is illustrated as a process in a schematic form with a start block 302 and an end block 318. It should be appreciated that discussion and description of the various embodiments of incentive programs and features thereof provided above applies equally to program 300; however, for the sake of brevity much of that discussion will not be repeated herein.

According to program 300, an entity is enrolled into an incentive program at block 304 thereby becoming a participant in the incentive program. In the illustrated embodiment, a currency card issuer operates in conjunction with the coordinator of the incentive program to implement program 300. Accordingly, the program participant in the illustrated example incentive program is also a cardholder with the currency card issuer and will be referred to as such. For purposes of the present discussion, each cardholder is assigned a cardholder account and is issued a currency card operable to debit the account. The currency card may be any type of card that can be used to perform monetary transactions, such as a credit card or debit card as examples. Enrollment in the incentive program at block 304 may occur before or after the cardholder is assigned a cardholder account and issued a currency card. In other words, in certain embodiments the cardholder may have an existing account with a currency card issuer and may be offered enrollment in the incentive program, as described above. Alternatively, the cardholder may be enrolled in the incentive program substantially simultaneously with being enrolled by the currency card issuer and thereby assigned an account and issued a currency card, also as described above. The particular details, features and options regarding the enrollment process may be found in the discussion above and will not be repeated for the sake of brevity.

In certain embodiments, the currency card issuer and the incentive program coordinator may join together as co-sponsors of the program 300. In other embodiments, the currency card issuer is the same entity as the incentive program coordinator, with only one entity, the currency card issuer, implementing and running the program 300. However, it should be appreciated that the discussed incentive program need not be used in conjunction with a currency card issuer. In such cases, the incentive program coordinator would be directly engaged with the incentive program participants in a variety of possible ways, with examples being described above. Those skilled in the art recognize that a variety of business relationships can be created to implement the incentive program effectively. As an example, in lieu of or in addition to a currency card issuer, program sponsors such as employers, financial companies, television networks or programs, video game manufacturers, digital music companies, and beverage companies may sponsor and/or implement the incentive program, as discussed above.

At block 306, the incentive program coordinator provides the cardholder with a selection of at least two participants of an event for the cardholder to choose from as the cardholder's one or more “picks”. In certain embodiments, the cardholder is not one of the event participants. Accordingly, the event participants may be characterized as something other than the participant cardholder. It should be appreciated that the terms “event participant” and “something other than the cardholder” as used in conjunction with FIGS. 15 and 16 are similar and/or equivalent to the term “at least something other than the participant” used above with reference to FIGS. 1 through 14. In certain embodiments, the terms “event participant” and “something other than the cardholder” are to be given the same meaning as “at least something other than the participant.” The event participants could be any number of possible items, entities or individuals, many examples of which are described in greater detail above, including but not limited to, sports teams, athletes, music artists, television program contestants, television program characters, video game characters, awards nominees, race horses, race cars, countries, stocks, and politicians. Similarly, the event of which the participants are involved is to be construed broadly as including any type of situation or event where the performance of an event participant can be measured in some way. Some examples of events include, but are not limited to, a competition, a reality television show, a television program, an awards competition, a celebrity awards show, a horse race, a car race, a sporting event, a comparison of the strengths of countries' currencies, the values of stocks, a political election, a video game, and an online video game.

At block 308, the cardholder chooses at least one event participant as their “pick.” In accordance with program 300, the selected or chosen event participant is an unrelated third party which has its performance evaluated to determine if rewards are given to the cardholder. In certain embodiments, the cardholder is provided a selection of at least two participants of one event and is allowed one selection. In other embodiments, the cardholder is allowed two or more selections or “picks” of event participants. In some embodiments, the cardholder is provided a selection of at least two participants for two or more events. In such cases, the cardholder may be allowed to choose one event participant “pick” for at least one event, or may be allowed to choose two or more event participant “picks” for at least one event. Additionally, the cardholder may select or choose event participants as “picks” for only some of the events as desired or may be required to make at least one “pick” for each event. In certain embodiments, the “picks” may be varied, changed and/or exchanged throughout the cardholder's participation in the incentive program.

Rewards are then given to the cardholder based on the performance of their selected event participant (or “pick”). In other words, when the cardholder's “pick” achieves a predetermined performance level, rewards are deposited into the cardholder's account. At block 310, the amount of rewards to be deposited based on actions or performance of the event participant is determined. The amount of rewards to be provided to the cardholder may be determined by assessing the performance level of the “pick.” Procedures for determining the amount of rewards are discussed in greater detail above and will not be repeated for the sake of brevity. In certain alternative embodiments, a combination of the cardholder's actions and the performance of the chosen event participant may determine the reward. Once the proper amount of rewards is determined, the rewards are deposited in the cardholder's account at block 312.

While as discussed above the rewards may be issued in a variety of different manners, for purposes of the discussion of the illustrated embodiments of FIGS. 15 and 16, the rewards are quantum of value which are able to accumulate in a cardholder's account, such as currency and points as examples. In certain embodiments, the currency card issuer will deposit points in the cardholder's account as rewards based on the performance of the cardholder's “pick.” Optionally, the points may be redeemable by the cardholder as currency. Regardless of the type of reward, the participant may redeem the reward in some manner at block 314. In a specific example, once a certain number of points accumulate in the cardholder's account, the cardholder may request that the currency card issuer issue a check to the cardholder for the amount of currency which corresponds to the amount of accumulated points to be redeemed. In another embodiment, rewards may be deposited as currency directly to the cardholder's account.

In certain embodiments, the incentive program is operable to convert at least a portion of the deposited and unredeemed rewards into additional “picks,” providing the cardholder with the possibility of receiving additional rewards based on the performance of the additional “pick” and preventing unredeemed rewards from accumulating indefinitely in cardholder accounts. Accordingly, rewards which are not redeemed by the cardholder at block 314 may be converted into additional “picks” at block 320. In certain embodiments, the rewards are points accumulated in the cardholder's account which may be converted. In other embodiments, the rewards are currency accumulated in the cardholder's account which may be converted. In yet other embodiments, the rewards are both points and currency, and the unredeemed rewards to be converted include only points, only currency, or a combination of points and currency. The additional “picks” may be selected event participants from the same event for which participants previously selected event participants at block 308. In other embodiments, the additional “picks” are selected event participants from one or more different events. It is contemplated that the additional “picks” referred to in block 320 may include one additional selected event participant, more than one selected event participant from the same event, or selected event participants from multiple events. Upon conversion of the unredeemed rewards into additional “picks,” the process returns to block 310 to determine the amount of rewards owed to the cardholder based on the performance of the additional “picks” and deposit the determined amount of rewards into the cardholder's account at block 312, as described above.

In addition to or in lieu of the conversion of unredeemed rewards at block 320, program 300 may optionally include the step of allowing the cardholder to contribute currency to receive additional “picks” at block 322. In certain embodiments, the contributed currency is separate from the rewards received at block 312. In other words, in such embodiments none of the contributed currency is rewards in the cardholder's account. The cardholder may choose to forego converting unredeemed rewards at block 320 and may solely contribute currency to receive the additional “picks” at block 322. In other embodiments, the cardholder may choose to do a combination of converting unredeemed rewards and contributing non-rewards currency, thereby using both methods together to receive additional “picks.” In a specific embodiment, the rewards are points and the conversion rate is 1 additional “pick” for every 100 points accumulated in the cardholder's account. Additionally, the cardholder may purchase additional points, the conversion rate being $1 for 10 points. As an example, a cardholder who accumulates 50 unredeemed points in their cardholder's account may receive 1 additional “pick” by converting the 50 unredeemed points and paying $5 for 50 additional points to reach the 100 total points required for an additional “pick.”

In certain embodiments, it is contemplated that the cardholder may redeem all of the deposited rewards at block 314. In other embodiments, it is contemplated that a portion of the rewards may be redeemed at block 314 and a portion of the rewards may be converted into additional “picks” at block 320. It is contemplated that, in some embodiments, the portion converted may be the remaining unredeemed rewards which have accumulated in the cardholder account and, in other embodiments, the portion converted may be only a portion of the remaining unredeemed rewards. In yet other embodiments, it is contemplated that all of the deposited rewards may be converted into additional “picks” at block 320, with none of the deposited rewards being redeemed at block 314. The conversion rate used by the incentive program to convert rewards into additional “picks” may be set as desired. In certain embodiments, the conversion rate may vary between cardholders and/or may vary for each cardholder throughout their participation in the incentive program. In a specific embodiment, the rewards are points and the conversion rate is 1 additional “pick” for every 100 points accumulated in the cardholder's account. As an example, a cardholder who accumulates 200 unredeemed points in their cardholder's account may receive 2 additional “picks” resulting from the conversion of the 200 points.

As illustrated in FIG. 15, after the cardholder redeems some or all of the rewards at block 314, the cardholder may terminate their enrollment in the incentive program at block 316. While the illustrated embodiment shows the option of the cardholder terminating their enrollment after redeeming rewards, the cardholder may terminate their enrollment in the program without redeeming rewards. In such situations, the cardholder may not have accumulated any rewards in their account and thus there are none to redeem, or the cardholder may chose to forego redeeming any accumulated rewards before terminating their enrollment in the incentive program. The termination of enrollment in the incentive program may be voluntary or involuntary, as discussed above. Although the enrollment termination block is shown as occurring after rewards are redeemed by the cardholder, it should be appreciated that in certain embodiments enrollment in the program may be terminated (voluntarily or involuntarily) at any time during the process of program 300. One potential reason for terminating entrollment in the incentive program may be that the cardholder has lost eligibility in the program. However, in other embodiments, eligibility cannot be lost. Once the cardholder is no longer participating in the incentive program 300, the incentive program for that cardholder participant comes to an end as represented by block 318. If the cardholder's enrollment in the program is not terminated, the program 300 may return to block 310 to determine rewards based on the performance of any “picks” remaining for the cardholder. If the cardholder has no remaining “picks,” in certain embodiments program 300 may return to block 306 to provide a selection of event participants for the cardholder to choose as one or more picks.

The present disclosure contemplates at least two approaches or procedures regarding the conversion process at block 320. In certain embodiments, the incentive program may automatically convert the unredeemed rewards to additional “picks” at certain times or events. In certain other embodiments, the cardholder may initiate the conversion of unredeemed rewards, as will be discussed in greater detail with reference to FIG. 16. It is contemplated that incentive programs may use only one of the two approaches, or a combination of the automatic and cardholder initiated conversion processes.

Regarding automatic conversion, the incentive program may be designed to automatically convert a certain amount of unredeemed rewards in the cardholder's account after a predetermined elapsed time from depositing the rewards in the account. In a particular embodiment, the incentive program may convert unredeemed rewards after 1 year from depositing the rewards. In other words, if the cardholder has not redeemed the rewards within 1 year from deposit, the rewards will be automatically converted by the incentive program into one or more additional “picks.” In other embodiments, the incentive program may be designed to convert unredeemed rewards into additional “picks” at the time of a particular event or occurrence, an example being accumulating a particular or predetermined amount of unredeemed rewards in an account. As a particular example, if a cardholder accumulates at least 500 unredeemed rewards in their cardholder account, the incentive program will automatically convert all or a portion of the unredeemed rewards into additional “picks” according to the program's conversion ratio.

It is contemplated that the additional “picks” resulting from automatic conversion could be selected in a variety of different manners. As an example, the additional “picks” could be randomly selected by the program. As another example, the additional “picks” could be selected by the program based on previous “picks” made by the cardholder and the cardholder's picking patterns. As a further example, at the time of enrollment the cardholder may choose additional “picks” that it desires the program to select if automatic conversion takes place.

Referring to FIG. 16, incentive program 300 from FIG. 15 is illustrated with an additional block step 319, according to another embodiment of the present disclosure directed to the cardholder initiated conversion approach. At block 319, the incentive program receives instructions from the cardholder to convert all or a portion of the cardholder's unredeemed rewards in the cardholder's account into one or more additional “picks.” In response to the cardholder's instructions, the incentive program converts the unredeemed rewards accordingly at block 320. It is contemplated that the cardholder's initiation of or the request for conversion of unredeemed rewards can occur through a variety of possible processes. In certain embodiments, the cardholder is able to access the incentive program and themselves convert unredeemed rewards into additional “picks” of their choice. In other embodiments, the cardholder must instruct the incentive program to convert unredeemed rewards. In certain embodiments, the cardholder may request that unredeemed rewards be converted into additional “picks” at any time and with any amount of unredeemed rewards accumulated in the cardholder's account. In other embodiments, the cardholder must accumulate a certain amount of unredeemed rewards in the cardholder's account before conversion into additional “picks” may be requested. As stated above, in certain embodiments, the cardholder may be able to contribute non-rewards currency in addition to the conversion of unredeemed rewards to receive the additional “picks.” As illustrated, following the conversion of awards at block 320, the program process returns to block 310 to determine the amount of rewards owed to the cardholder based on the performance of their additional “pick”.

While some embodiments have been illustrated and described in detail in the drawings and foregoing description, the same is to be considered as illustrative and not restrictive in character, it being understood that only selected embodiments have been shown and described and that all changes and modifications that come within the disclosure as defined in the claims are desired to be protected.

1. A system, comprising:
a cardholder account;
a currency card operable to debit the cardholder account; and
an incentive program system operable to:
receive one or more picks of something other than the cardholder from the cardholder;
determine the amount of rewards owed to the cardholder based on the performance of the one or more picks;
deposit the determined amount of rewards into the cardholder account; and
convert at least a portion of the rewards in the cardholder account into one or more additional picks of something other than the cardholder.

2. The system of claim 1, wherein the incentive program system is further operable to convert an amount of non-rewards currency into one or more additional picks of something other than the cardholder.

3. The system of claim 1, wherein the incentive program system is further operable to convert a combination of at least a portion of the rewards in the cardholder account and an amount of non-rewards currency into one or more additional picks of something other than the cardholder.

4. The system of claim 1, wherein the incentive program system is operable to automatically convert an unredeemed amount of the deposited rewards at a predetermined elapsed time from the deposit of the determined amount of rewards.

5. The system of claim 1, wherein the incentive program system is further operable to receive instructions from the cardholder to convert an unredeemed amount of the deposited rewards into one or more additional picks of something other than the cardholder, wherein the converting occurs in response to the receiving instructions.

6. The system of claim 1, wherein the rewards are points.

7. The system of claim 1, wherein the rewards are currency.

8. The system of claim 1, wherein the currency card is a debit card.

9. The system of claim 1, wherein the currency card is a credit card.

10. The system of claim 1, wherein the something other than the cardholder is selected from the group consisting of a member of a television program, a sports team, an awards nominee, a video game character, a music artist, and an athlete.

11. The system of claim 1, wherein the one or more picks can be exchanged for other picks during the operation of the incentive program system.

12. A method, comprising:
providing a currency card to a cardholder operable to debit a cardholder account;
operating an incentive program associated with the cardholder account for use with an event having at least two event participants;
providing the cardholder the ability to select at least one of the participants of the event as a pick;
depositing rewards in the cardholder account based on performance of the selected participant of the event; and
converting at least a portion of the rewards into at least one additional pick of event participants.

13. The method of claim 12, further comprising converting an amount of non-rewards currency into at least one additional pick of event participants.

14. The method of claim 12, wherein the converting includes automatically converting an unredeemed amount of the rewards at a predetermined elapsed time from the depositing.

15. The method of claim 12, further comprising receiving at least one additional pick of event participants from the cardholder in exchange for an unredeemed amount of the rewards, wherein said receiving occurs prior to said converting.

16. The method of claim 12, wherein the event is a television program.

17. The method of claim 16, wherein the television program is a reality television program.

18. The method of claim 12, wherein the event is a video game.

19. The method of claim 18, wherein the video game is an online video game.

20. The method of claim 12, wherein the event is an awards ceremony.

21. A method, comprising:
operating an incentive program;
entering participants in the incentive program;
providing each of the participants a participant account;
providing a selection of at least two of something other than the participant to each participant to be chosen as at least one pick;
rewarding the participants if their chosen picks achieve a predetermined performance level by depositing rewards into the corresponding participant accounts; and
automatically converting unused amounts of the deposited rewards into at least one additional pick for each affected participant of something other than the participant after a predetermined elapsed time from depositing the rewards into the participant accounts.

22. The method of claim 21, wherein the predetermined elapsed time is one year.

23. The method of claim 21, wherein the predetermined performance level is winning a competition.

24. The method of claim 21, wherein the predetermined performance level is winning an award.

25. The method of claim 21, wherein the unused amounts of deposited rewards are any amounts which have not been redeemed by the corresponding participants.

26. The method of claim 21, further comprising providing each of the participants a currency card operable to debit the participant account.

27. The method of claim 26, wherein a currency card issuer operates the incentive program.

28. The method of claim 26, wherein a currency card issuer and a co-sponsor operate the incentive program.

29. The method of claim 28, wherein the co-sponsor is a commercial digital music company.

30. The method of claim 28, wherein the co-sponsor is a beverage company.

31. The method of claim 26, wherein the currency card is a debit card.

32. The method of claim 26, wherein the currency card is a credit card.

33. The method of claim 21, wherein the rewards are points.

34. The method of claim 21, wherein the rewards are currency.

35. The method of claim 21, wherein the at least one pick can be exchanged picks made by other participants of the incentive program.

36. The method of claim 21, wherein the at least one additional pick is chosen at random by the incentive program.

37. A system comprising an incentive program operable to:
provide the choice of at least two participants in at least one event to a cardholder for the cardholder to choose from, wherein the cardholder has a cardholder account and a currency card operable to debit the cardholder account;
receive at least one selection of at least one event participant from the cardholder;
deposit points into the cardholder account when the at least one selected participant achieves a predetermined performance level with respect to the event;
receive instructions from the cardholder to convert at least one of the points in the cardholder account to at least one additional selection of at least one participant in at least one event; and
convert the at least one point to at least one additional selection according to the received instructions.

38. The system of claim 37, wherein the at least one event is a competition and the predetermined performance level is winning the competition.

39. The system of claim 37, wherein the incentive program is further operable to deposit additional points into the cardholder account when the at least one additional selected participant achieves a predetermined performance level.

40. The system of claim 37, wherein the incentive program is further operable to provide currency to the cardholder in exchange for at least one deposited point.
